(19) United States
(12) Patent Application Publication
(10) Pub. No.: US 2008/0002942 A1
(43) Pub. Date: Jan. 3, 2008

(54) Method and apparatus for creating a custom track

(76) Inventors: Peter White, Dallas, TX (US); Michael Wayne Shore, Dallas, TX (US); Wolfred Charles Attal, Austin, TX (US)

Correspondence Address: Ashley N. Moore, Suite 4450, 325 N. Saint Paul Street, Dallas, TX, 75201, US

(21) Appl. No.: 11/588,627

(22) Filed: Oct. 27, 2006

Related U.S. Application Data
(63) Continuation-in-part of application No. 11/491,269, filed on Jul. 21, 2006.
(60) Provisional application No. 60/802,913, filed on May 24, 2006.

(51) Int. Cl. H04N 5/93

(52) U.S. Cl. 386/52

(57) ABSTRACT

A method and system for creating and editing video and/or audio tracks is described. The method includes providing at least one artist, venue, and track available for selection and providing at least one clip associated with the at least one artist, venue, and track. The method also includes allowing a user to create a custom track from the at least one clip. The system includes a plurality of video cameras for recording a live performance at a plurality of positions. The system also includes at least one server for storing a plurality of video clips created from the plurality of video cameras and an application stored on the at least one server for allowing a user to access the plurality of video clips via the Internet. The clips (video, audio, or still images) may be edited in low-definition while the user's end product is a high-definition track.

### CROSS-REFERENCE TO RELATED APPLICATIONS

This application is a continuation-in-part of U.S. patent application Ser. No. 11/491269 filed Jul. 21, 2006, which claims priority to U.S. Patent Application 60/802913, filed May 24, 2006. This patent application is also related in subject matter to U.S. patent application Ser. No. 11/497596 filed Aug. 2, 2006.

### TECHNICAL FIELD

The present invention generally relates to the storage and creation of video and/or audio tracks and, more particularly, to creating custom video tracks from multiple video sources.

### BACKGROUND OF THE INVENTION

Millions of music fans attend concerts at numerous venues every year. As many artists and recording companies have recognized, video and/or audio recordings of live concerts are a very popular and successful sales item. However, in most cases fans must wait for months, if not years, to obtain quality live recordings of a concert—if the recordings are available at all. In addition, many fans would prefer to have a recording of the concert that they attended as opposed to another venue that was chosen either by the artist or recording company for mass production.

Embodiments of the present invention allow a user to create and purchase video tracks, audio tracks, still images, or any combination thereof from a performance that was captured via audio and/or video, e.g., a concert or a pay-per-view television show.

### SUMMARY OF THE INVENTION

One embodiment relates to a method for creating a custom track. The method includes providing at least one artist, venue, and track available for selection and providing at least one high-definition clip associated with the at least one artist, venue, and track. The method also includes allowing a user to create one or more custom tracks from the at least one clip, or from multiple clips, coming from one or more venues, or one or more live performances. The clips, whether video, audio, or still images, may be edited in low-definition.

Another embodiment relates to a system for capturing and storing video tracks from a live performance. The system includes a plurality of video cameras for recording a live performance in high-definition at one or more positions. An additional embodiment allows for multiple audio tracks as well. The system also includes at least one server for storing a plurality of audio clips, video clips, or still images created from the one or more video cameras and sound receiving devices, and an application stored on the at least one server, where the application allows a user to edit the plurality of clips (video, audio, and/or still images) in low-definition. The at least one server can be an e-commerce or other type of server thereby allowing a user to access the plurality of video clips via the Internet, and, if desired, make a custom and personalized copy of a the videos, images, and audio tracks captured and stored.

### BRIEF DESCRIPTION OF THE DRAWINGS

Further aspects of embodiments of the present invention will be apparent from the following description of the preferred embodiments as illustrated in the accompanying drawings in which:

FIG. 1 illustrates a block diagram of a system in accordance with an embodiment of the present invention;

FIG. 2 illustrates a screen shot in accordance with an embodiment of the present invention;

FIG. 3 illustrates a screen shot in accordance with an embodiment of the present invention;

FIG. 4 illustrates a screen shot in accordance with an embodiment of the present invention;

FIG. 5 illustrates a screen shot in accordance with an embodiment of the present invention;

FIG. 6 illustrates a screen shot in accordance with an embodiment of the present invention;

FIG. 7 illustrates a screen shot in accordance with an embodiment of the present invention;

FIG. 8 illustrates a screen shot in accordance with an embodiment of the present invention;

FIG. 9 illustrates a block diagram of a system in accordance with an embodiment of the present invention; and

FIG. 10 illustrates a diagram of a system in accordance with an embodiment of the present invention.

### DETAILED DESCRIPTION OF THE PREFERRED EMBODIMENTS

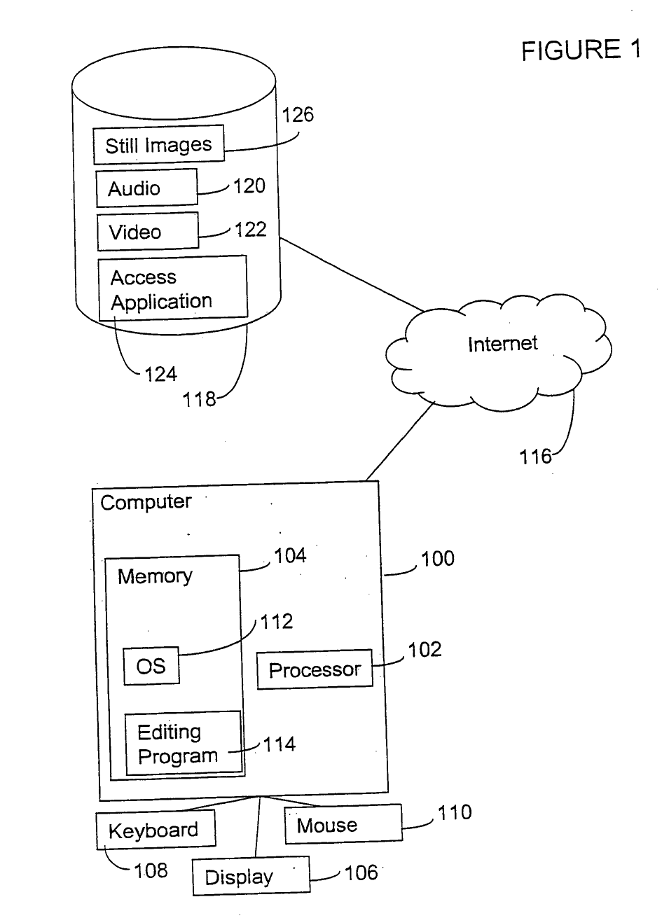

FIG. 1 illustrates a computer 100 for use with some of the embodiments of the present invention. The computer 100 is operated by a user or a venue to create a video or audio track. The computer 100 includes a processor 102, memory 104, a display 106, a keyboard 108, and a mouse 110. Stored within the memory 104 is at least an operating system 112 and an editing program 114. The editing program 114 is used to create the video or audio tracks. The computer 100 accesses a server 118 storing video tracks 122, audio tracks 120, and an access application 124 through the Internet or a private network.

The server 118 stores audio tracks, video tracks, and/or still images 126 that may be obtained from various cameras and sound receiving devices at venues located around the world. The tracks maybe fed to the server 118 live via streaming video and audio, the tracks may be stored in another location and then downloaded to the server 118; or a combination thereof. For example, a venue may choose to download the tracks to another location or system in order to manipulate the files to include timing information or perform other editing of the tracks. The venue may also add embedded information regarding the date of recordation and the venue name. In addition, some venues may wish to delay user access to the tracks until after the concert has ended. Alternatively, instead of the venue maintaining control over the video clips, audio clips, and still images, the artist, label, or other entity may maintain control. Although embodiments of the present invention may reference a live musical performance, embodiments of the present invention are also applicable to backstage recordings, television shows, pay-per-view shows, etc. According to aspects of the present invention, a user may edit or customize the viewing of, e.g., a basketball game, a television show, or a reality television show by switching camera angles, audio tracks, etc.

In addition, the tracks available for download at the server 118 may be ISO images, streaming video, or other format such as MP3, or NWEG-2 or 4. Streaming video allows for digital rights management (DRM) to prevent unauthorized copying of content. ISO images may have a DRM watermark to identify unauthorized reproductions. Although embodiments of the present invention may use ISO images, streaming video, and watermarks, it will be readily understood by one skilled in the art that various other formats of video and video protection may be utilized without departing from aspects of the present invention.

The tracks may also be tiered based on a specific relationship, such as time or number of hits. For example, the first tier may be the most recent tracks to be added to the server 118 and/or the tracks with the most hits. The second tier may be made up of less requested tracks and/or tracks that have been available for a specific length of time, e.g., one month, one year, etc. The older or least favorite tracks may then be archived. The first tier of tracks may be provided to the user by default, or all tracks from all tiers may be provided to the user for selection.

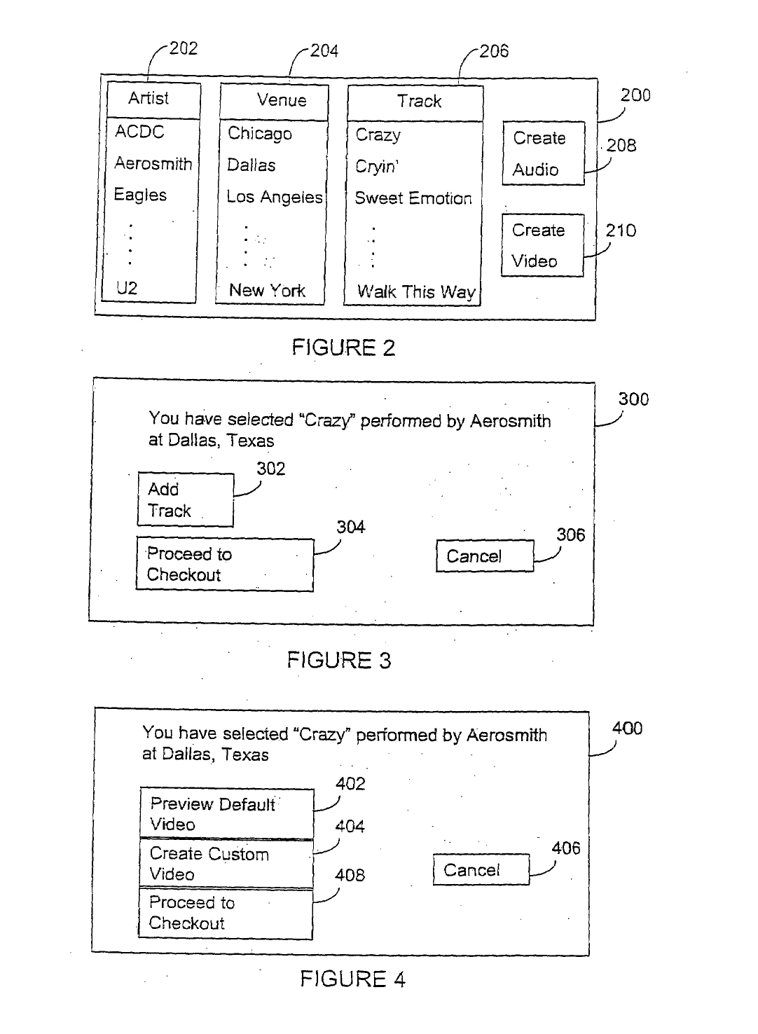

When tracks become available at the server 118 for download by the public, the access application 124 may be initiated to allow a user to select and purchase video tracks, audio tracks, still images, or any combination thereof. The user may select low-definition or High-Definition (“HD”) for editing and/or download. For example, a user may edit the video (detailed below) in low-def in order to save time, and later order or retrieve the finished HD video. Alternatively, if the user has adequate bandwidth and storage, editing may be done in HD. FIG. 2 illustrates an exemplary screen shot of the access application 124 in accordance with an embodiment of the present invention. Although the access application 124 is shown and described with a particular layout, it will be readily apparent to one skilled in the art that many aspects of the screen shot may be altered without departing from embodiments of the present invention.

A user, through the computer 100, accesses the Internet 116 in order to start the access application via the screen shown in the screen shot 200. The screen shot 200 includes an artist window 202, a venue window 204, and a track window 206. The user is able to make a selection from any of the artist window 202, venue window 204, or track window 206. Preferably, after a first selection is made, for example the artist Aerosmith, the venue window 204 and track window 206 adjust selections accordingly. For instance, after Aerosmith is selected as an artist, the venues available for selection in the venue window 204 would be the venues at which Aerosmith has played. In addition, the track window 206 would adjust its selections to be the songs that Aerosmith has performed at each venue. Although the adjustment of selections from the windows 202, 204, and 206 is preferred, it is also possible to merely black out non-available selections or leave all selections available regardless of previous selections made by the user. The user may select one or more tracks at a time in order to create a cd of one or more songs or a video track of one or more performances at one or more venues.

When the user has determined the artist, venue, and track or portion of a track from which he wishes to create a video or audio track, the user then determines to create either an audio track via button 208 or a video track via button 210.

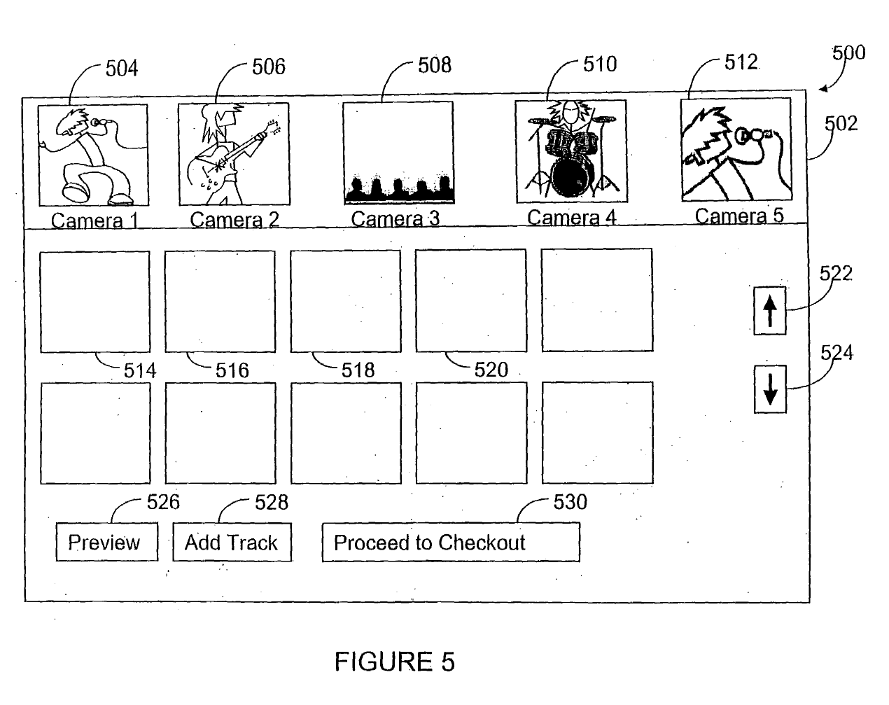

If the user presses button 208, the user proceeds to screen shot 300 illustrated in FIG. 3. The user may either add additional tracks to the previously selected track via button 302 or proceed to checkout via button 304. The user may also cancel the order by pressing a cancel button 306. In addition, although the following descriptions relate to creating a custom video track from multiple camera sources, it will be understood by one skilled in the art that a user may create custom audio tracks from multiple sound recording devices. In a manner similar to that shown in FIGS. 5-8, a user may select a particular sound recording device from multiple sound recording devices placed strategically throughout the venue. For example, the user may wish to purchase an audio track composed of audio recorded from a device near a drummer, a device near the lead singer, and a device near the lead guitarist or any combination thereof.

Instead, if the user presses button 210, the user proceeds to screen shot 400 illustrated in FIG. 4. Although the remainder of the process will be described with reference to one video track, as noted above, it is also contemplated that the user may select multiple video tracks, multiple audio tracks, or a combination of both.

In a preferred embodiment of the screen shot 400 shown in FIG. 4, a confirmation of the chosen track, artist, and venue appears on the screen. The access application 124 provides the option of previewing a default video track previously created for purchase by pressing button 402. The user may instead prefer to create a custom video track by pressing button 404. If the user selects the default video track, the user may preview the track with, for example, a pop-up window. The user may then choose to purchase the default video track or cancel the operation and create a custom video track. If the user selects the default video track, he may then select additional video tracks to include in his purchase, or the user may purchase the one video track by checking out via button 408. The user may also cancel the order by pressing the cancel button 406.

If the user decides to create a custom track, he proceeds to screen shot 500 illustrated by FIG. 5. Although the following video editing application is described with particular characteristics, it will be understood by one skilled in the art that any method of video editing may be used in accordance with embodiments of the present invention. In this particular embodiment, the editing program utilized to create screen shot 500 is located on the user's computer 100.

In a preferred embodiment, a bar 502 across the top portion of the screen 500 previews tiles 504, 506, 508, 510, and 512 associated with a particular camera or camera angle. For example, multiple cameras may have recorded various areas of the stage and/or crowd during a concert. The tiles 504, 506, 508, 510, and 512 maybe representative of a still image from the video track. Alternatively, the tiles 504, 506, 508, 510, and 512 may be of a specific color or have specific text on them to denote different tiles. The user may then drag the tiles to placeholders 514, 516, 518, and 520 on the lower portion of the screen 500. The user may also scroll through the placeholders 514, 416, 518, and 520 with scroll buttons 522 and 524.

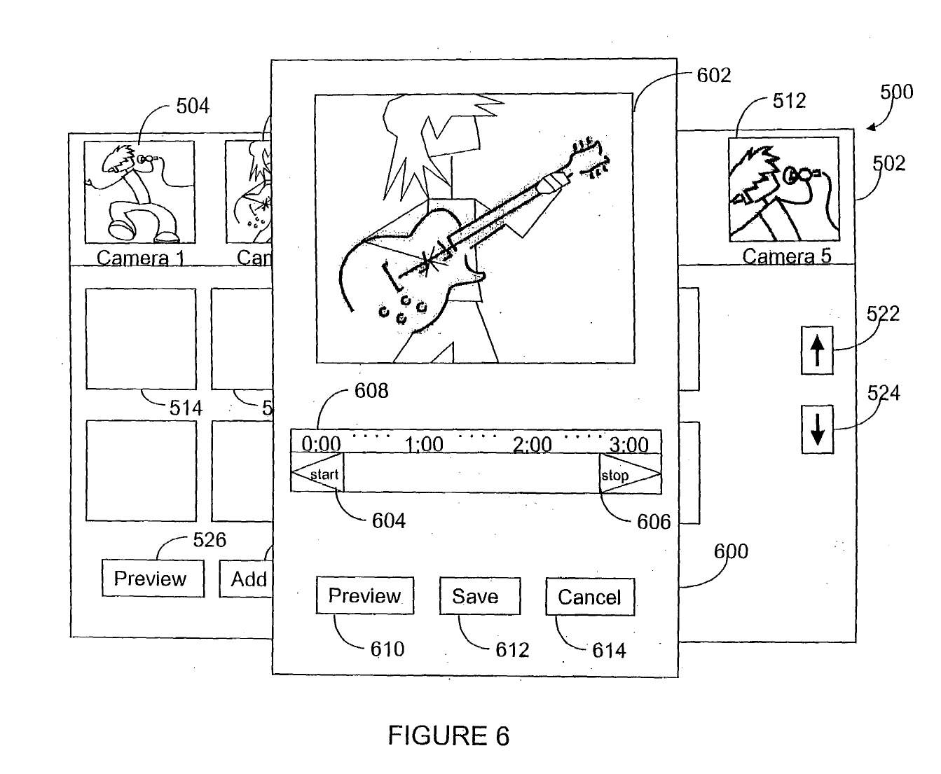

The user may select a particular portion of a video clip represented by a tile 504, 506, 508, 510, and 512 by selecting a particular start and end time as shown in FIG. 6. For example, the selected video clip 602 may appear in a window 600. The start and end times may be adjusted by sliding start flag 604 and stop flag 606 along a time bar 608. Once a start and stop time are selected, the user may preview the edited video clip 602 by pressing the preview button 610. The edited video clip 602 may be saved by pressing save button 612 or edits may be canceled by pressing the cancel button 614. When the edited video clip 602 is saved or canceled, the user returns to screen 500 shown in FIG. 5.

The user then may continue by selecting another tile depicting another video clip from a different camera. The user then determines the appropriate start time to coincide with the end time of the previous edited video clip. Of course, the user may select additional video clips, tracks, or both to create a complete video or use only one video track. Once the video is completed, the user may preview the entire video, or portions thereof, in a pop-up window or other preview screen by pressing button 526. The user may add special effects, fades between camera angles, etc. before completing the video. When complete, the user may continue by selecting another track by pressing button 528 or proceed to check out by pressing button 530. If the user selects another track, the user repeats the process by displaying the tiles 504, 506, 508, 510, and 512 associated with the selected track. When adding another track, the user may select another artist or another venue, or the same artist and venue.

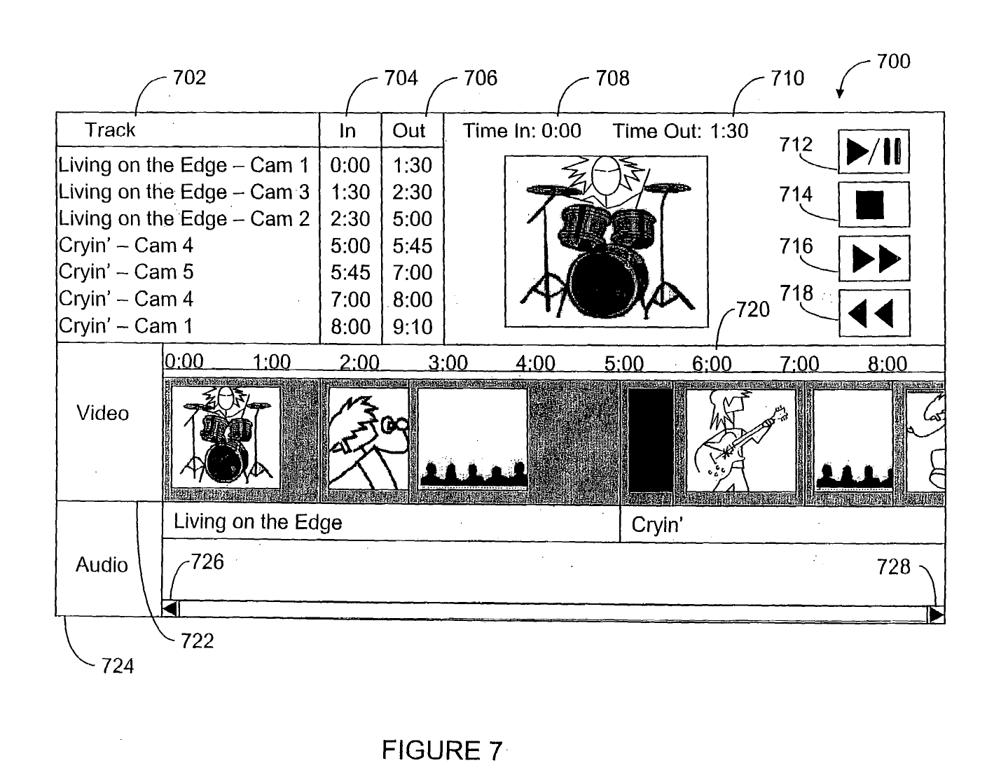

FIG. 7 illustrates an alternate embodiment of a screen shot 700 for editing video tracks. In this screen shot 700 an upper portion of the screen allows a user to view the tracks in a track window 702. The in and out times are also viewable through an in window 704 and an out window 706. The user may add, remove, select, delete, etc. tracks from the track window 702 as desired. The remainder of the upper portion of the screen may be used to view the video tracks and edit the in and out times. For example, a time in window 708 allows the user to edit the in time of the chosen video track. Similarly, a time out window 710 allows the user to edit the out time of the chosen video track. The user may play, pause, stop, rewind, or fast forward the video track as desired with buttons 712, 714, 716, and 718.

A lower portion of the screen 700 may be devoted to timing of the video clips. In this embodiment, a time bar 720 is shown along with the selected clips at their respective in and out times. The lower portion of the screen 700 may include a video portion 722 for viewing the selected video clips and an audio portion 724 for viewing the selected audio tracks. In addition, the lower portion may include scroll buttons 726 and 728 for scrolling through the edited tracks.

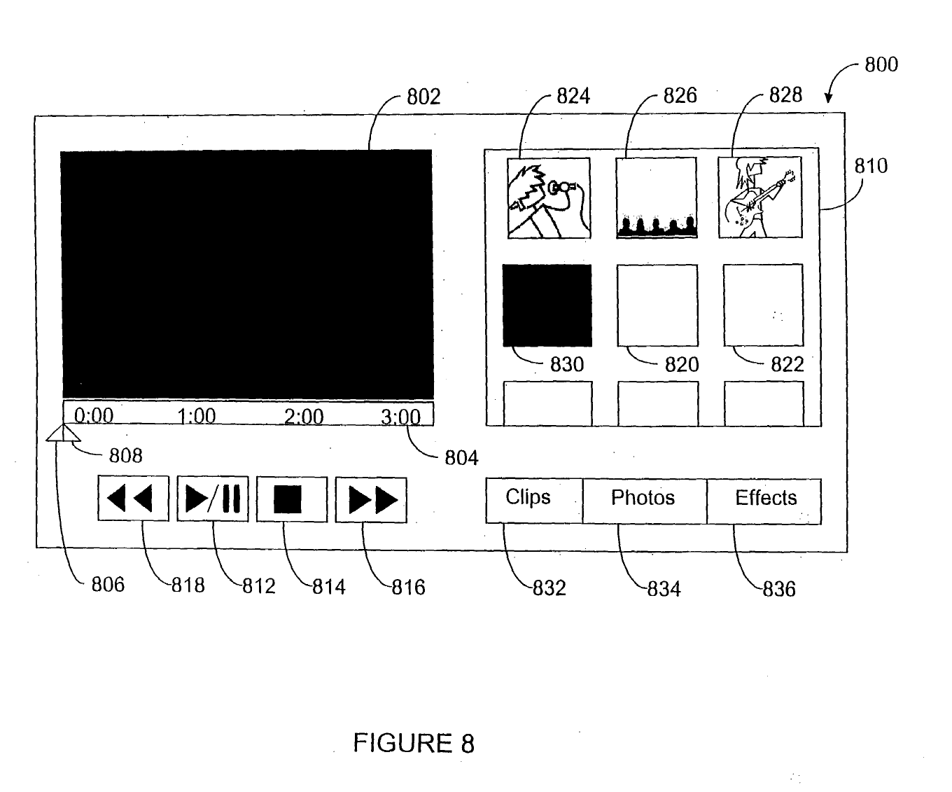

In FIG. 8, a screen shot 800 of an additional alternate embodiment is illustrated. In this particular embodiment, a preview screen 802 is located at one portion of the screen 800 with a time bar 804 at the lower portion of the preview screen 802. The time bar 804 allows the user to edit the start and end times of the clip with arrows 806 and 808. Similar to the previous embodiments, the user may view the clip with play/pause, stop, fast forward, and rewind buttons 812, 814, 816, and 818. Another portion of the screen includes a clip window 810. The clip window 810 includes placeholders 820 and 822 for placing clips 824, 826, 828, and 830. The user may import additional clips or photos by pressing the clips button 832 or photos button 834, respectively. The user may also add special effects to the video track by pressing the effects button 836. In addition, the user or the venue may customize titles of the tracks, cd, or dvd. The cover art for the cd/dvd may also be customized by the user or venue.

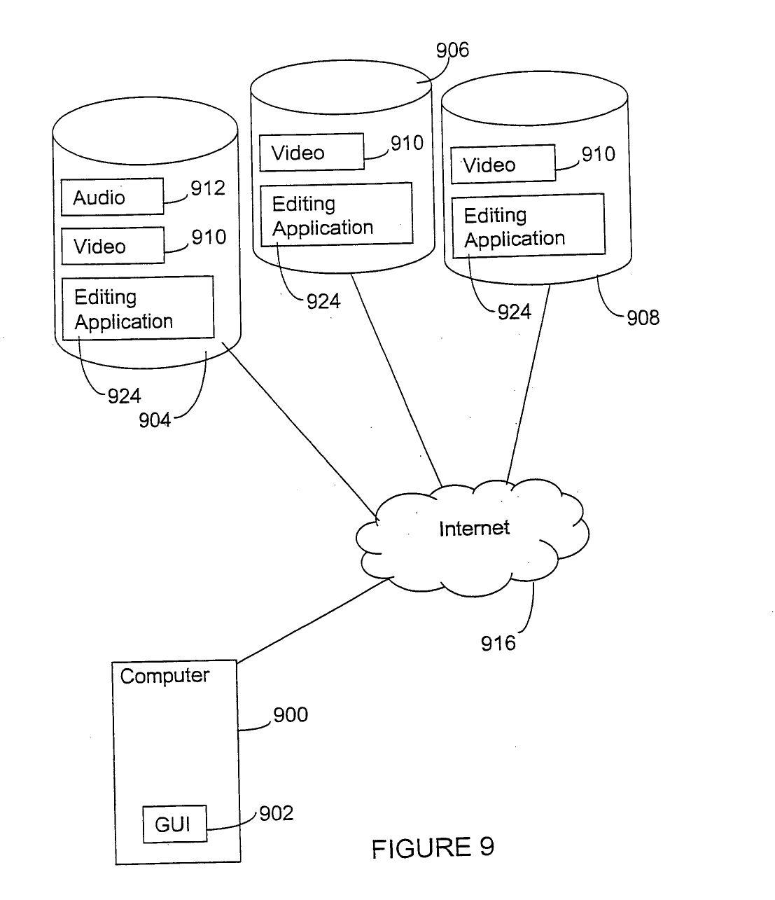

FIG. 9 illustrates an alternate embodiment of a system of the present invention. Here, the user may access the Internet 916 via a computer 900 in order to access a web-based editing application 924. In this embodiment, the computer 900 accesses servers 904, 906, and 908 to create and purchase audio and/or video tracks. The servers 904, 906, 908, store video tracks 910, audio tracks 912, and an editing application 924. The editing application 924 and access to stored video and audio tracks 910 and 912 are run remotely via a graphical user interface (GUI) 902 at the user's computer 900. The GUI 902 allows the user to view, create, and edit video and audio tracks 910 and 912 in a manner similar to that shown in FIGS. 2-8.

Although the present embodiment illustrates three servers for storing video and audio tracks as well as the editing application, it will be understood by one skilled in the art that fewer servers or more servers may be utilized in accordance with aspects of the present invention. A distributed, networked system as shown can allow storage capacity in the petabyte range with downloads of a gigabyte-per-second or more. By adjusting the number of servers, the type of storage systems used, as well as utilizing parallel data input and output, storage capacity and download speed can be increased or decreased as desired and as economics dictate. For example, a petabyte of storage and gigabyte-per-second download speeds support the storage and download of high-definition digitized video, should the user desire high-definition video.

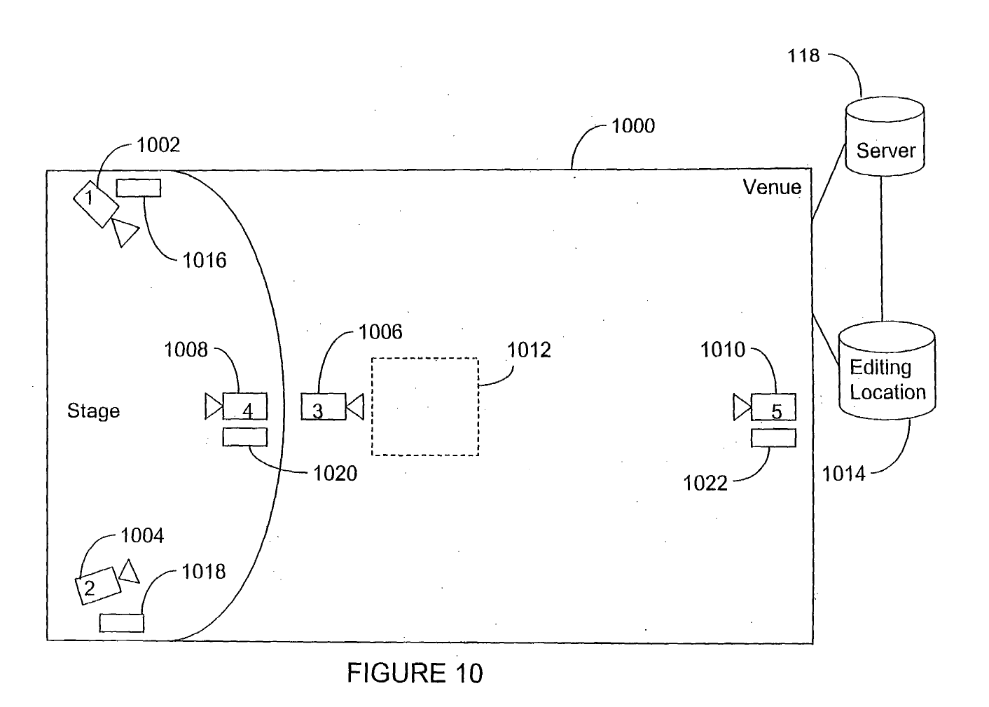

FIG. 10 depicts an exemplary system for capturing video tracks in accordance with an embodiment of the present invention. As previously noted, a venue 1000 may wish to capture video from several angles from one or more cameras 1002, 1004, 1006, 1008, and 1010. In the preferred embodiment, there are several cameras 1002, 1004, 1006, 1008, and 1010 that capture video from several different locations. For example, cameras 1 and 2 1002 and 1004 may capture video from the rear corners of the stage. Camera 3 1006 may capture video of the audience. The cameras may pan to different areas or specifically capture only one location. Camera 3 1006 may be fixed to a particular location, such as an area 1012 defined by the venue 1000. Members of the audience may stand in the designated area 1012 to ensure that they are captured on the video of camera 3 1006. In the preferred embodiment, camera 5 1010 is located at the far end of the venue 1000 from the stage. In a similar manner, sound recording devices 1016, 1018, 1020, 1022 may also be placed throughout the venue 1000, either together or separate from the video cameras 1002, 1004, 1006, 1008, 1010. Although the preferred embodiment shown in FIG. 10 depicts a particular camera/sound recording device layout with five cameras and four sound recording devices, it will be understood by one skilled in the art that fewer cameras and recording devices or more cameras and recording devices may be utilized and the placement of the cameras/sound recording devices may be varied as desired by the particular venue 1000.

The video recorded from the camera 1002, 1004, 1006, 1008, and 1010 may be fed to the server 118 for availability to the public, or the video may be fed to an editing storage location 1014. Alternatively, the video could be fed, to both the server 118 and the editing storage location 1014. At the editing storage location 1014, the video can be edited, default video tracks may be set up, digital management rights and/or watermarks may be embedded, or other actions may be performed on the video. Once the actions are completed, the video may then be uploaded to the server 118. One server 118 is illustrated in this particular embodiment, however, as previously described with reference to FIG. 9, several servers may be utilized in conjunction with embodiments of the present invention.

In addition, the venue 1000 may allow attendees of the concert a discount or a certain number of free downloads in exchange for paying for a ticket to the concert. For example, the venue 1000 may stamp or print a discount code on the ticket itself or hand out coupons at the venue 1000 itself. The attendee may then go to the Internet, access the GUI or application and enter the discount code when creating a track. Also, the venue may receive a fee for every purchased track recorded at that venue.

It is to be understood that the above-described embodiments are simply illustrative of the principles of the present invention. Various modifications may be made by those skilled in the art without departing from aspects of the embodiments of the present invention. For example, various changes may be made to the GUI, access application, and screen shots depicted in FIGS. 2-8 while still embodying aspects of the present invention. In addition, the access application and/or the editing application may be stored at the user's computer and not at the server. The methods and applications described above may be implemented in hardware, firmware, software, or combinations thereof, or in a computer program product tangibly embodied in a computer readable storage device. It should also be understood that where a video clip is illustrated in some of the exemplary embodiments, in some instances this can be simply an audio clip, a synchronized audio/video clip, or an unsynchronized audio/video stream.

What is claimed is:

1. A method for creating a custom track, the method comprising:
providing at least one artist, venue, and track available for selection;
providing at least one clip associated with the at least one artist, venue, and track; and
allowing a user to create a high-definition custom track from the at least one clip by editing the at least one clip in low-definition.

2. The method of claim 1, wherein the track is a video track.

3. The method of claim 1, wherein the clip is a video clip.

4. The method of claim 1, wherein the at least one clip comprises a first video clip from a first camera and a second video clip from a second camera.

5. The method of claim 1, wherein the step of allowing a user to create a custom track comprises the steps of:
allowing the user to select a start time and an end time of a first video clip of the at least one clip; and
allowing the user to select a second video clip of the at least one clip.

6. The method of claim 5 further comprising the step of creating a complete video track from the first and second video clip.

7. A system for capturing and storing video tracks from a live performance, the system comprising:
a plurality of video cameras for recording a live performance in high-definition at a plurality of positions;
at least one server for storing a plurality of video clips created from the plurality of video cameras;
an application stored on the at least one server for allowing a user to access the plurality of video clips via the Internet and edit the plurality of video clips in low-definition.

8. The system of claim 7, wherein the plurality of video cameras comprises:
a first video camera for recording a first portion of a stage; and
a second video camera for recording a first portion of a crowd attending the live performance.

9. The system of claim 7, wherein the video clips are streaming video.

10. The system of claim 9, wherein the user accesses the application during the live performance to watch the streaming video.

11. The system of claim 7, wherein the user accesses the application after completion of the live performance.

12. The system of claim 7, wherein the video clips are ISO images.

13. The system of claim 7, wherein the at least one server comprises a plurality of servers that are capable of at least one of parallel input and parallel output.

14. The system of claim 7, wherein the at least one server is capable of storing at least one petabyte of data.

15. The system of claim 7, wherein the system is capable of at least one gigabyte-per-second downloads.

16. The system of claim 7, wherein the at least one server stores at least one video clip and an access application.

17. The system of claim 7, wherein the at least one server stores an editing application.

18. The system of claim 7, wherein the editing application operates to display a graphical user interface on the user's computer.

19. The system of claim 7, wherein the at least one server stores an access application.

20. The system of claim 7, wherein the at least one server stores at least one audio track.

21. The system of claim 7, further comprising an editing location for storing the at least one video clip.

22. The system of claim 21, wherein the editing location is not accessible by a user through the Internet.

23. The system of claim 21, wherein the editing location transfers the at least one video clip to the at least one server.

24. The system of claim 7, wherein the at least one video clip is unedited.

25. The system of claim 7, wherein the at least one video clip includes time information.

26. The system of claim 7, wherein the at least one video clip includes a water-mark.

27. The system of claim 7, wherein the at least one video clip is an edited video clip.

28. The system of claim 7, wherein the edited video clip includes video clips from the plurality of video cameras.
